(19) United States
(12) Patent Application Publication
(10) Pub. No.: US 2024/0015109 A1
(43) Pub. Date: Jan. 11, 2024

(54) METADATA BASED EFFICIENT PACKET PROCESSING

(71) Applicant: CHECK POINT SOFTWARE TECHNOLOGIES LTD., Tel Aviv (IL)

(72) Inventor: Oren Markovitz, Tel Aviv (IL)

(21) Appl. No.: 17/810,856

(22) Filed: Jul. 6, 2022

(51) Int. Cl. H04L 47/62; H04L 47/52; H04L 49/90; H04L 49/901

(52) U.S. Cl. CPC H04L 47/621; H04L 47/522; H04L 49/9042; H04L 49/901

(57) ABSTRACT

A method and device are presented for decreasing processing cycles spent forwarding packets of a communication from receive queues to at least one transmit queue of a network interface controller. When received, packets are placed into a receive queue based on property(ies) of a leading packet. Buffer metadata including transmit information is associated with each communication. Processor circuitry transfers the packets from each of the receive queues to a transmit queue and the buffer metadata is used to determine how to transmit the packet and how to process the packet before transmission.

### TECHNICAL FIELD

The present disclosure relates generally to network communications and more particularly to packet processing performed by network interface controllers.

### SUMMARY

Network interface controllers (also referred to as network cards) receive data payloads (e.g., packets) from different sources (e.g., ports). These data packets are often described as being received by receive modules of the network card. That is, the receive queues may store pointers to the packets that are saved in memory by the receiving modules. Each receive module has multiple receive queues and the network card can be programmed to place the packets of the received packet on one of the receive queues.

Network cards also include transmit modules for transmitting packets. The packets may be placed into multiple transmit queues and, from there, into different outputs (e.g., ports). For example, the transmit module can be programmed to associate a transmit queue (or several queues) with a transmit port.

To send the received packets, forwarding modules read from the receive queues and send the received packets by writing pointers to the packets on one of the transmit queues. For example, an electronic device may include two network cards each with single ports and each having multiple receive queues and multiple transmit queues. Each network card may include a forwarding and control module implemented on central processing unit (CPU) cores for reading and writing data packets to and from the receiving and transmit queues of the network card.

In the above example, the forwarding module reads packets from the receive queues, processes the headers of the read packets, and determines a transmit queue to place the packet into (e.g., by determining a destination port for the packet and identifying the transmit queue associated with the destination port), and writes the packet to the proper transmit queue.

In a common implementation, a CPU can fetch multiple packet pointers from the receive queue in a single read. But, to forward a packet, the CPU reads and processes each of the packet headers. This processing of the packet headers results in cache misses and is cycle consuming.

In a general embodiment, the present disclosure provides a method for reducing the number of transmit queues using buffer metadata, and for decreasing processing cycles spent forwarding packets from receive queues to transmit queues of a network interface controller. In this way, the present disclosure improves the number of packets processed per second.

In an exemplary embodiment, the metadata-based processing described herein was found to provide a factorial improvement in forwarding performance, because the forwarding modules (e.g., a central processing unit) does not need to process the header for each packet to determine which transmit queue a packet should be placed in. Instead, transmit information is included in buffer metadata associated with a communication. The packets in the receive queue may all be placed in a single transmit queue without analyzing the packets individually and the buffer metadata may be used to determine how to transmit the packet (e.g., the transmitting port) and how to process the packet (e.g., adding virtual local area network tagging) before transmission. That is, the forwarding module may read a batch of pointers from the receive queues and pass/write the entire batch to the transmit queue without performing any read of the packets themselves—reducing the number of reads from, e.g., 8 or 16 for 8 packets to a single read, dramatically improving the cache performance.

While a number of features are described herein with respect to embodiments of the invention; features described with respect to a given embodiment also may be employed in connection with other embodiments. The following description and the annexed drawings set forth certain illustrative embodiments of the invention. These embodiments are indicative, however, of but a few of the various ways in which the principles of the invention may be employed. Other objects, advantages, and novel features according to aspects of the invention will become apparent from the following detailed description when considered in conjunction with the drawings.

### BRIEF DESCRIPTION OF THE DRAWINGS

The annexed drawings, which are not necessarily to scale, show various aspects of the invention in which similar reference numerals are used to indicate the same or similar parts in the various views.

FIG. 1 is a schematic diagram of an embodiment of an electronic device for performing metadata-based processing of packets between receive queues and transmit queues.

FIG. 2 is a schematic diagram of an embodiment of the electronic device of FIG. 1 showing movement of packets between receive queues and a transmit queue.

FIG. 3 is a schematic diagram of an embodiment of the electronic device of FIG. 1 showing movement of packets between receive queues and transmit queues.

FIG. 4 is a schematic diagram of an exemplary communication.

FIG. 5 is a flow diagram depicting an embodiment of a method executed by processor circuitry for metadata-based processing of packets between receive queues and transmit queues.

The present invention is described below in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

### DETAILED DESCRIPTION

According to a general embodiment, a method and device is presented for decreasing processing cycles spent forwarding packets of a communication from receive queues to at least one transmit queue of a network interface controller. When received by a receiving network interface controller (NIC), packets are placed into a receive queue based on property(ies) of a leading packet. Buffer metadata including transmit information is associated with each communication. Processor circuitry (e.g., host processor circuitry separate from the receiving NIC and transmitting NIC) transfers the packets from each of the receive queues to a transmit queue of a transmitting NIC. The transmitting NIC uses the buffer metadata to determine how to transmit the packet and may also specify operations for processing the packet before transmission.

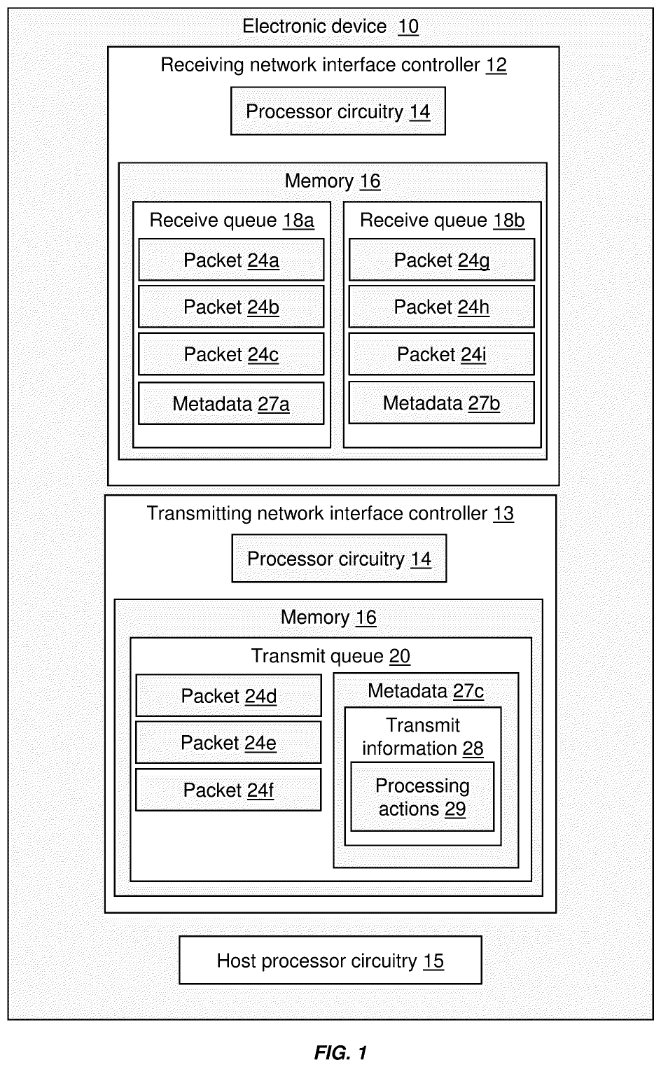

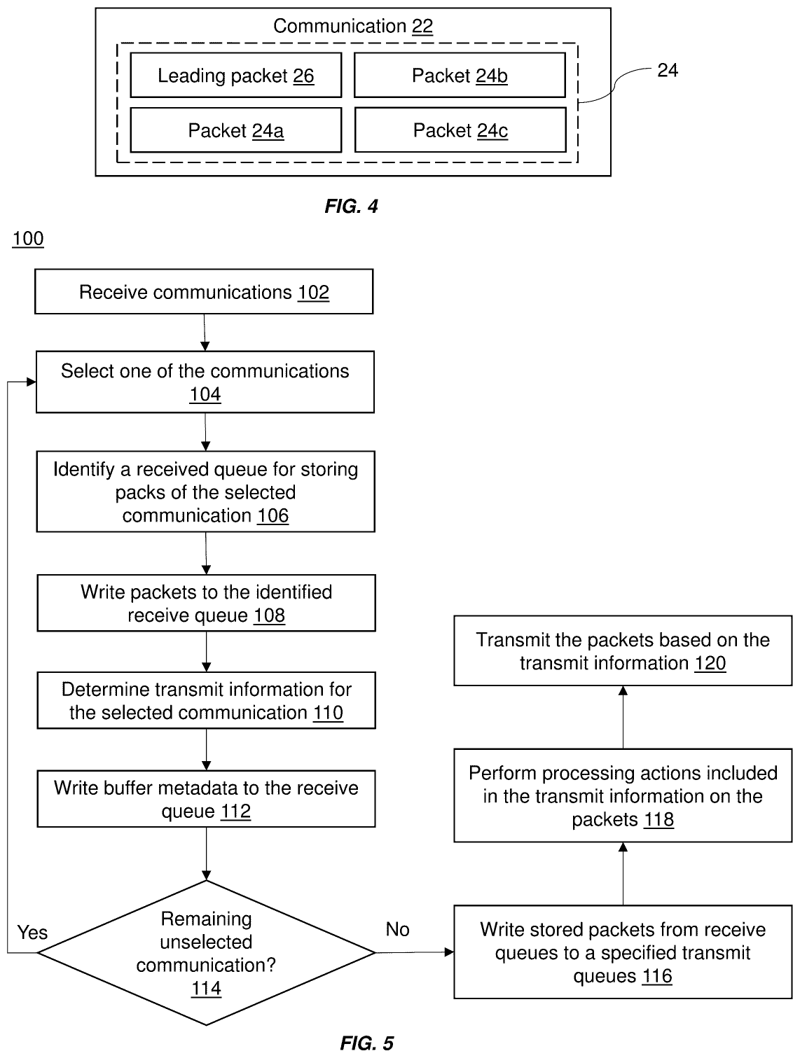

In the embodiment shown in FIG. 1, an electronic device 10 includes a receiving network interface controller (NIC) 12, a transmitting NIC 13, and host processor circuitry 15. The transmitting network interface controller 12 includes memory 16 for storing receive queues 18. Similarly, the transmitting network interface controller 13 includes memory 16 for storing at least one transmit queue 20. The receiving network interface controller 12 receives communications 22, with each communication 22 including packets 24a-24i having a leading packet 26 (an exemplary communication 22 is shown in FIG. 4). The processor circuitry 14 of the receiving network interface controller 12 (also referred to as receiving processor circuitry 14) causes the packets 26 for a communication 22 to be stored in a receive queue based on a property of the leading packet 26 for the communication 22. For each of the received communications 22, the processor circuitry 14 of the receiving network interface controller 12 also determines transmit information 28 based on the property of the leading packet 26. The transmit information 28 includes processing actions 29 to be performed on the packets 24 of the communication 22 (e.g., before transmission of the packets 24 from the transmit queue 20). The receiving processor circuitry 14 writes buffer metadata 27a-27c associated with the packets 26 to the receive queue 18. The buffer metadata 27 includes the transmit information 28 determined for the communication 22.

For each of the receive queues 18, the stored packets 26 in each receive queue 18 are written to a specified transmit queue 20 of the transmitting network interface controller 13 based on an association between the receive queue 18 and the specified transmit queue 20. For example, all packets 24 stored in a particular receive queue 18 may be written to the same transmit queue 20 by the host processor circuitry 15. In one example, all packets 24 stored in the receive queues 18 may be written to the same transmit queue 20 (e.g., when there is only one transmit queue 20).

For each communication 22 stored in the transmit queue 20, the processor circuitry 14 of the transmitting network interface controller 13 (also referred to as transmitting processor circuitry 14) also performs on the packets 24 the processing actions 29 included in the transmit information 28 for the communication 22. The transmitting processor circuitry 14 also transmits the packets 24 of the communication 22 stored in the transmit queue 20 based on the transmit information 28 included in the buffer metadata 27 that is associated with the communication 22.

In one embodiment, the processing actions 29 include at least one of adding virtual local area network (VLAN) tagging to the communication, or applying network address translation (NAT) to the communication. For example, when packets 24 are sent from a receive queue 18 on the receiving network interface controller 12 to a transmit queue 20 on the transmitting network interface controller 13, the transmitting network interface controller 13 is typically not aware of processing performed on the packets 24. As an example, the lost information may include the port that the packets were received on, operations performed on the header that removed any information, removal of wrappers or tagging (e.g., VLAN tagging), etc. A description of the processing performed on the packets 24 may be included in the metadata buffer 27 as transmit information 28.

Because the transmit information 28 included in the metadata buffer 27 may include the port for transmitting the packet 24, the number of transmit queues on each network interface controller 12, 13 may be reduced to one (i.e., because the transmit information 28 may be included in the metadata 27 instead of based on the transmit queue 18 that a packet 24 is placed into). For example, the transmit information 28 may include at least one of a received port that the communication was received on, a transmission port for transmitting the communication, etc.

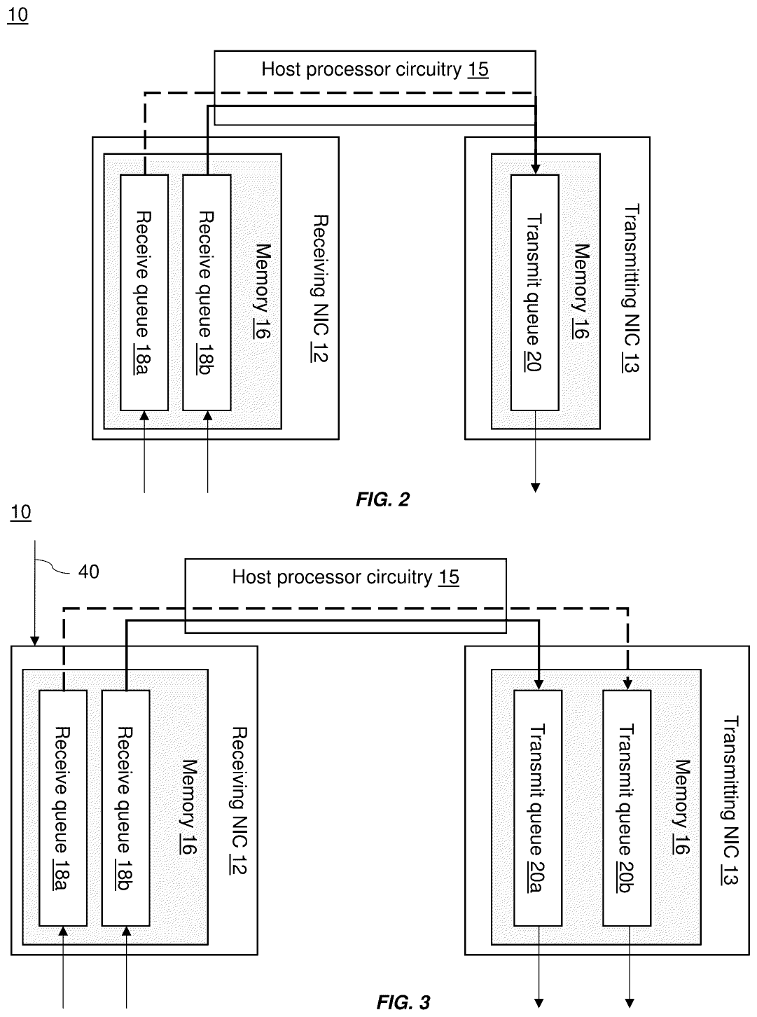

In one embodiment, the processor circuitry 14 includes at least one transmitting network interface controller 13. Each of the at least one transmitting network interface controller 13 may have a single transmit queue, such that a number of transmit queues equals a number of transmitting network interface controllers. For example, in FIG. 2 the number of transmitting network interface controllers 13 is one and the number of transmit queues 20 is one. As an example, there may be one transmitting network interface controller 12, such that there is one transmit queue 20 for receiving packets 24 from the receive queues 18.

In one embodiment, the processor circuitry 14 includes multiple receiving network interface controllers 12 (i.e., network interface controllers that receive packets 24). For each of the communications 22 received by one of the receiving network interface controllers 12, the transmit information 28 may identify as a reception network interface controller the one of the multiple receiving NICs that received the communication. That is, the transmit information 28 may identify which network interface controller 12 received the packets 24 of the communication 22 (e.g., which may be used by the transmitting network interface controller 13 to determine processing to perform on the packets 24 of the communication 22).

In the embodiment shown in FIGS. 2 and 3, the electronic device 10 includes a a receiving network interface controller 12 having two receive queues 18a, 18b and a transmitting network interface controller 13 having one transmit queue 20 in FIG. 2 and two transmit queues 201, 20b in FIG. 3. In FIGS. 1 and 2, each of the receive queues 18a, 18b are associated with the receiving network interface controller 12. Each of the receive queues 18 may be associated with one of the transmit queues. For example, in FIG. 2 the receive queues 18a, 18b are associated with the transmit queue 20. In FIG. 3 receive queue 18a is associated with transmit queue 20b and receive queues 18b is associated with transmit queue 20a.

The present disclosure is not limited to a specific number of network interface controllers, receive queues, or transmit queues, but may be applied using any number of network interface controllers, receive queues, and transmit queues.

As described above, the communication 22 may include multiple packets 24 (also referred to as data packets). Each of the packets 24 of the communication 22 may be destined for the same port (e.g., associated with a particular receive queue 18), such that the destination of one packet may be used to determine the destination of each of the packets 24 in the communication 22. The leading packet 26 refers to the packet analyzed by the processor circuitry 14 to determine the destination of the packets 24 of the communication 22. The leading packet 26 may refer to any packet 24 of the communication 22 that includes the necessary information for the receiving processor circuitry 14 to determine a destination of the packets 24 of the communication 22. For example, the leading packet 26 may refer to the first packet 24 of the communication 22 that is received by the receiving network interface controller 12.

The host processor circuitry 15 may be a central processing unit (CPU) (e.g., separate from the network interface controllers 12, 13) or a processor included in one or more of the network interface controllers 12, 13. In the embodiment shown in FIG. 2, the host processor circuitry 15 controls movement of packets 24 from the receive queues 18 located on the receiving network interface controller 12 to the transmit queue 20 located on the transmitting network interface controller 13. That is, the host processor circuitry 15 may pull packets 24 from receive queues 18a and 18b and initiate transfer of these packets 24 to the transmit queue 20 associated with the receive queues 18a, 18b.

The host processor circuitry 15, receiving network interface controller 12, and transmitting network interface controller 13 are each not limited to one CPU or processor but may include lesser or greater numbers. Additionally, each of the processor circuitry 14, 15 referred to herein may be a separate core or thread of a single processor.

The network interface controllers 12, 13 and host processor circuitry 15 may store the packets 24 in memory 16 and move the packets 24 into and out of queues 18, 20 by moving pointers to the packets 24. For example, the host processor circuitry 15 may cause the packets 24 to be moved from the receive queues 18 to the associated transmit queues 20 by reading from each receive queue 18 a batch of packet pointers (e.g., 8, 16, 32, etc.) in one read operation and by then writing the entire batch of read packet points in one write operation to the proper transmit queue 20. For example, in FIG. 2, the host processor circuitry 15 may read eight packet pointers from receive queue 18b and write the packet pointers to transmit queue 20. The processor circuitry 14 may then read eight packet pointers from receive queue 18a and write the packet pointers to transmit queue 20.

In one embodiment, the host processor circuitry 15 is not located on computer hardware separate from at least one of the receiving network interface controller 12 or transmitting network interface controller 13 but is instead embodied as a processor included in the receiving network interface controller 12 or the transmitting network interface controller 13. For example, the network interface controller 12, 13 may be a network card and the processor may be a part of the network card. Processing and movement of the packets 24 may be performed independent of the processor circuitry used to move packets 24 from the receive queue 18 to the transmit queue 20, such as a processor separate from the network interface controllers 12, 13 or a processor included on one of the network interface controllers 12, 13.

For each of the received communications 22, the receiving processor circuitry 14 identifies one of the receive queues 18 as an identified receive queue 18 for storing the packets 24 of the communication 22 based on a property of the leading packet 26. For each of the received communications 22, the receiving processor circuitry 14 causes the packets 26 to be stored on the identified receive queue 18 as stored packets. For each of the receive queues 18, processor circuitry separate from the receiving processor circuitry 14 and transmitting processor circuitry 14 may cause the stored packets 26 to be written to the associated transmit queue 20.

As described above, the receiving processor circuitry 14 may determine which receive queue 18 to place packets 24 of a communication 22 into based on a property of the leading packet 26. In one embodiment, the receiving processor circuitry 14 analyzes the leading packet 26 to identify which receive queue 18 to place the packets 24 of the communication 22 into. For example, the receiving processor circuitry 14 may identify the identified receive queue based on a header of the leading packet 26. As an example, the header of the leading packet 26 may indicate a port that the associated communication 22 should be sent to. The receiving processor circuitry 14 may then determine which transmit queue 20 is associated with the indicated port (e.g., using a lookup table) and place the packets 24 of the communication 22 into the receive queue 18 associated with the determined transmit queue 20.

For example, in one embodiment, the receiving processor circuitry 14 may be physically separate from the receiving network interface controller 12 (such as a CPU). The receiving processor circuitry 14 may receive the leading packet 26 and determine which receive queue 18 to place packets 24 of the communication 22 into as described above. The receiving processor circuitry 14 may then instruct other circuitry located on the receiving network interface controller 12 (e.g., processors located on the receiving network interface controller 12), such that the following packets 24 of the communication 22 are stored in the determined receive queue 18. In this example, the processor circuitry 14 separate from the network interface controller 12 may only receive the leading packet 26 before the packets 24 of the communication 22 are placed into the receive queue 18.

In another embodiment, the receive queue 18 is identified based on a message 40 received by the receiving network interface controller 12 indicating the identified receive queue 18. That is, instead of the receiving network interface controller 12 analyzing the leading packet 26 to identify the receive queue 18, the receiving network interface controller 12 may instead receive a message 40 (e.g., from a CPU) specifying which receive queue 18 to place the packets 24 of the communication 22 into.

The packets may be received from any suitable device capable of communicating via a network. For example, the packets may be received from computer devices (i.e., electronic devices), such as Internet of things (IoT) devices, smart home accessories, medical equipment, computers, smart phones, etc.

The electronic device 10 may be any suitable computer device capable of receiving and processing packets. For example, the electronic device 10 may be connected to a network for receiving the packets.

The network interface controllers 12, 13 (also referred to as a communication interface or network interface) may each be a network card, a wireless network adaptor, an Ethernet network interface, or any suitable device that provides an interface to a network. The network interface controllers 12, 13 may be communicatively coupled to a computer readable medium, such that the network interface controllers 12, 13 are able to send data stored on the computer readable medium across the network and store received data on the computer readable medium. The network interface controllers 12, 13 may each also be communicatively coupled to the related processor circuitry 14 such that the processor circuitry 14 is able to control operation of the respective network interface controller 12, 13. The network interface controller 12, 13 and associated memory (also referred to as computer readable medium), and processor circuitry 14 may be communicatively coupled through a system bus, mother board, or using any other suitable manner as will be understood by one of ordinary skill in the art.

The processor circuitry 14 (i.e., host processor circuitry 15, receiving processor circuitry 14, and transmitting processor circuitry 15) may have various implementations. For example, the processor circuitry 14 may include any suitable device, such as a processor (e.g., CPU), programmable circuit, integrated circuit, memory and I/O circuits, an application specific integrated circuit, microcontroller, complex programmable logic device, other programmable circuits, or the like. The processor circuitry 14 may also include a non-transitory computer readable medium, such as random-access memory (RAM), a read-only memory (ROM), an erasable programmable read-only memory (EPROM or Flash memory), or any other suitable medium. Instructions for performing the method described below may be stored in the non-transitory computer readable medium and executed by the processor circuitry 14. The processor circuitry 14 may be communicatively coupled to the computer readable medium and network interface controller through a system bus, mother board, or using any other suitable structure known in the art.

In the embodiment shown in FIG. 5, an exemplary method 100 executed by processor circuitry is shown for metadata-based processing of packets between receive queues and at least one transmit queue. In process block 102, communications 22 are received. In process 104, one of the communications 22 is selected. In process block 106, one of the receive queues 18 is identified as an identified receive queue 18 for storing the packets 24 of the communication 22 based on a property of the leading packet 26. In process block 108, the packets 24 of the selected communication 22 are written to the identified receive queue 18 as stored packets. In step 110, the processor circuitry (e.g., receiving processor circuitry 14) determines transmit information 28 based on the property of the leading packet 26. In step 112, buffer metadata 27 associated with the packets 24 is written to the identified receive queue.

In decision block 114, a check is performed to determine if there are any remaining unselected communications. If yes, then processing returns to process block 104. If not, then processing continues to process block 116. In process block 116, the stored packets for each of the receive queues 18 are written to a specified transmit queue using the host processor circuitry 15. In process block 118, for each communication 22 stored in the transmit queue 20, the processing actions 29 included in the transmit information 28 for the communication 22 are performed on the packets 24 of the communication 22 (e.g., using the transmitting processor circuitry 14). In step 120, transmitting the packets of the communication based on the transmit information included in the buffer metadata that is associated with the communication.

While blocks 104, 106, 108, 110, and 112 are described above as being performed after receiving the communications 22 in process block 102, process block 106, 108, 110, and 112 may be performed as communications 22 are received. That is, as a communication 22 is received, a receive queue for storing the packets 24 of the communication 22 may be identified, the packets 24 for the communication 24 may be written to the identified receive queue 18, transmit information may be determined for the communication 24, and buffer metadata 27 including the transmit information may be written to the receive queue.

Similarly, while process block 112 is described above as occurring after writing all of the communications to the receive queues 18. Process block 112 may instead be performed periodically (e.g., at a given frequency).

All ranges and ratio limits disclosed in the specification and claims may be combined in any manner. Unless specifically stated otherwise, references to “a,” “an,” and/or “the” may include one or more than one, and that reference to an item in the singular may also include the item in the plural.

Although the invention has been shown and described with respect to a certain embodiment or embodiments, equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A method executed by processor circuitry for metadata-based processing of packets between receive queues and at least one transmit queue, the method comprising:
receiving communications, wherein each of the communications includes packets having a leading packet;
for each of the received communications:
identifying one of the receive queues as an identified receive queue for storing the packets of the communication based on a property of the leading packet;
writing the packets to the identified receive queue as stored packets;
determining using the processor circuitry transmit information based on the property of the leading packet, wherein the transmit information includes processing actions to be performed on the packets of the communication before transmission of the packets from the transmit queue; and
writing buffer metadata associated with the packets to the identified receive queue, wherein the buffer metadata includes the transmit information determined for the communication;
for each of the receive queues, writing the stored packets to a specified transmit queue using the processor circuitry based on an association between the receive queue and the specified transmit queue; and
for each communication stored in the at least one transmit queue:
performing on the packets of the communication the processing actions included in the transmit information for the communication; and
transmitting the packets of the communication based on the transmit information included in the buffer metadata that is associated with the communication.

2. The method of claim 1, wherein the processing actions include at least one of adding virtual local area network (VLAN) tagging to the communication, or applying network address translation (NAT) to the communication.

3. The method of claim 1, wherein the transmit information includes at least one of a received port that the communication was received on or a transmission port for transmitting the communication.

4. The method of claim 1, wherein the processor circuitry includes at least one transmitting network interface controller (NIC) for transmitting the communication, each of the at least one transmit queue is included in the at least one transmitting NIC, and each of the at least one transmitting NIC has a single transmit queue, such that a number of transmit queues equals a number of transmitting NICs.

5. The method of claim 4, wherein the processor circuitry includes one transmitting NIC, such that there is one transmit queue for receiving packets from the receive queues.

6. The method of claim 1, wherein:
the processor circuitry includes multiple receiving network interface controllers (NICs);
each of the communications are received by a one of the multiple receiving NICs; and
for each of the communications, the transmit information identifies as a reception NIC the one of the multiple receiving NICs that received the communication.

7. The method of claim 6, wherein the packets are written to the identified receive queue as stored packets by one of the multiple receive NICs.

8. The method of claim 1, wherein the property of the leading packet used to identify the identified receive queue is a header of the leading packet.

9. An electronic device configured to perform metadata-based processing of packets between receive queues and at least one transmit queue, the electronic device comprising:
a receiving network interface controller (NIC) including:
memory for storing the receive queues, wherein:
the receiving NIC is configured to receive communications; and
each of the communications includes packets having a leading packet;
processor circuitry configured to:
for each of the received communications:
identify one of the receive queues as an identified receive queue for storing the packets of the communication based on a property of the leading packet;
cause the packets to be stored on the identified receive queue as stored packets, such that:
for each of the receive queues, the stored packets are written to a specified transmit queue based on an association between the receive queue and the specified transmit queue;
determine transmit information based on the property of the leading packet, wherein the transmit information includes processing actions to be performed on the packets of the communication; and
cause buffer metadata associated with the packets to be stored on the identified receive queue, wherein the buffer metadata includes the transmit information determined for the communication;
a transmitting NIC including:
memory for storing the at least one transmit queue;
processor circuitry configured to:
for each communication stored in the at least one transmit queue:
perform on the packets of the communication the processing actions included in the transmit information for the communication; and
transmit the packets of the communication based on the transmit information included in the buffer metadata that is associated with the communication.

10. The electronic device of claim 9, wherein the processing actions include at least one of adding virtual local area network (VLAN) tagging to the communication, or applying network address translation (NAT) to the communication.

11. The electronic device of claim 9, wherein the transmit information includes at least one of a received port that the communication was received on or a transmission port for transmitting the communication.

12. The electronic device of claim 9, wherein the transmitting NIC includes at least one transmitting NIC, and each of the at least one transmitting NIC has a single transmit queue, such that a number of transmit queues equals a number of transmitting NICs.

13. The electronic device of claim 12, wherein the processor circuitry includes one transmitting NIC, such that there is one transmit queue for receiving packets from the receive queues.

14. The electronic device of claim 9, wherein:
the electronic device includes multiple of the receiving NIC;
each of the communications are received by a one of the multiple receiving NICs; and
for each of the communications, the transmit information identifies as a reception NIC the one of the multiple receiving NICs that received the communication.

15. The electronic device of claim 9, further comprising host processor circuitry configured to, for each of the receive queues, write the stored packets to the specified transmit queue based on the association between the receive queue and the specified transmit queue.

16. The electronic device of claim 9, wherein the property of the leading packet used to identify the identified receive queue is a header of the leading packet.

17. A receiving network interface controller (NIC) configured to perform metadata-based processing of received packets for transmission by a transmitting NIC having at least one transmit queue, the receiving NIC comprising:
memory for storing receive queues, wherein:
the receiving NIC is configured to receive communications; and
each of the communications includes packets having a leading packet;
processor circuitry configured to:
for each of the received communications:
identify one of the receive queues as an identified receive queue for storing the packets of the communication;
cause the packets to be stored on the identified receive queue as stored packets, such that:
for each of the receive queues, the stored packets are written to a specified transmit queue of the at least one transmit queue based on an association between the receive queue and the specified transmit queue;
determine transmit information based on the property of the leading packet, wherein the transmit information includes processing actions to be performed on the packets of the communication; and
cause buffer metadata associated with the packets to be stored on the identified receive queue, wherein the buffer metadata includes the transmit information determined for the communication, such that:
when the communication is stored in the transmit queue, the transmitting NIC performs on the packets of the communication the processing actions included in the transmit information for the communication; and
transmits the packets of the communication based on the transmit information included in the buffer metadata that is associated with the communication.

18. The receiving NIC of claim 17, wherein the processing actions include at least one of adding virtual local area network (VLAN) tagging to the communication, or applying network address translation (NAT) to the communication.

19. The receiving NIC of claim 17, wherein the transmit information includes at least one of a received port that the communication was received on or a transmission port for transmitting the communication.

20. The receiving NIC of claim 17, wherein the property of the leading packet used to identify the identified receive queue is a header of the leading packet.
